(19) United States
(12) Patent Application Publication
(10) Pub. No.: US 2009/0254286 A1
(43) Pub. Date: Oct. 8, 2009

(54) Systems and Methods for Modeling Surface Properties of a Mechanical Component

(75) Inventors: Sonia Tulyani, Manchester, CT (US); Alexander Staroselsky, Avon, CT (US); Igor I. Fedchenia, West Hartford, CT (US); Hongmei Wen, South Windsor, CT (US); Clark V. Cooper, Glastonbury, CT (US); Susanne M. Opalka, Glastonbury, CT (US)

Correspondence Address: PRATT & WHITNEY, 400 MAIN STREET, MAIL STOP: 132-13, EAST HARTFORD, CT, 06108, US

(73) Assignee: PRATT & WHITNEY, East Hartford, CT (US)

(21) Appl. No.: 12/084,607

(22) PCT Filed: Dec. 2, 2005
(86) PCT No.: PCT/US2005/043883

§ 371 Date: May 6, 2008

(51) Int. Cl. G06F 19/00; G06G 7/48

(52) U.S. Cl. 702/34; 703/7

(57) ABSTRACT

There is a method for modeling the surface fatigue life of a mechanical component. The method has the following steps: a) modeling the surface fatigue life of the mechanical component on an atomistic scale to form an atomistic model, b) modeling the surface fatigue life of the mechanical component on a mesoscale to form a mesoscale model, c) modeling the surface fatigue life of the mechanical component on a macroscale to form a macroscale model, and d) testing the surface fatigue life of the mechanical component. Feedback from the macroscale model is employed at least once to validate the atomistic model. Feedback from the macroscale model is employed at least once to validate the mesoscale model. Feedback from the testing is employed at least once to validate the macroscale model. There is also an interactive, multiscale model for prediction surface fatigue life or degradation rate for a mechanical component.

### CROSS-REFERENCE TO A RELATED APPLICATION

The present application is related to the following copending and commonly-owned application: PCT Application “Method and System for Developing Lubricants, Lubricant Additives, and Lubricant Base Stocks Utilizing Atomistic Modeling Tools,” Attorney Docket No. 0002293WOU, EH-11696, filed Dec. 2, 2005. The contents of the aforementioned PCT Application is hereby incorporated by reference herein in its entirety.

### GOVERNMENT RIGHTS IN THE INVENTION

The invention was made by or under contract with the National Institute of Standards and Technology (NIST) of the United States Government under contract number 70NANB0H3048.

### BACKGROUND OF THE INVENTION

1. Field of the Invention

The invention relates to systems and methods for modeling the surface fatigue life and surface degradation rate of a mechanical component that is subject to repeated mechanical and/or thermal stress. The invention more particularly relates to a method for modeling the surface fatigue life or surface degradation rate of a gear.

2. Description of the Prior Art

Measurement of the surface fatigue life and surface degradation rate of mechanical components has been unpredictable. Most models developed to date for predicting and/or characterizing surface fatigue life and surface degradation rate of mechanical components have been empirical and not derived directly from intrinsic features, such as physical properties of the components (including lubricants), surface phenomena, environmental and process conditions, and interaction between components.

It would be desirable to have systems or models for predicting and characterizing the surface fatigue life and surface degradation rate of a mechanical component that is subject to repeated mechanical and/or thermal stress. It would be further desirable to have systems or models for predicting and characterizing the surface fatigue life and surface degradation rate of a gear system.

### SUMMARY OF THE INVENTION

According to the present invention, there is a method for modeling the surface fatigue life or surface degradation rate of a mechanical component. The method has the following steps: a) modeling the surface fatigue life of the mechanical component on an atomistic scale to form an atomistic model, b) modeling the surface fatigue life of the mechanical component on a mesoscale to form a mesoscale model, c) modeling the surface fatigue life of the mechanical component on a macroscale to form a macroscale model, and d) testing the surface fatigue life of the mechanical component. Feedback from the mesoscale model is employed at least once to validate the atomistic model. Feedback from the macroscale model is employed at least once to validate the mesoscale model. Feedback from the testing is employed at least once to validate the macroscale model.

Further according to the present invention, there is an interactive, multiscale model for predicting surface fatigue life or degradation rate for a mechanical component. The model has in sequence the following: a) an atomistic submodel, b) a mesoscale submodel, c) a macroscale submodel, and d) a test device for determining the surface fatigue life or degradation rate for a mechanical component. Each of the submodels and the test device has an output. The output from the mesoscale submodel is employed to validate the atomistic submodel. The output from the macroscale submodel is employed to validate the mesoscale submodel. The output from the test device is employed to validate the macroscale submodel. The validation of each of the submodels occurs at least once.

### DESCRIPTION OF THE FIGURES

FIG. 1 shows a schematic diagram of the system and method of modeling the surface life fatigue or surface degradation rate of a spur gear according to an embodiment of the present invention.

FIG. 2 shows a schematic diagram of the atomistic model of the system and method of FIG. 1.

FIG. 3 shows a schematic diagram of the mesoscale model of the system and method of FIG. 1.

FIG. 4 shows a schematic diagram of the macroscale model of the system and method of FIG. 1.

FIG. 5 shows a schematic diagram of more particular features of the system and method of FIG. 1.

FIG. 6 shows a perspective view of an example of a gear system useful in or carrying out the system and method of FIG. 1.

### DETAILED DESCRIPTION OF THE INVENTION

It was surprisingly found that the surface life fatigue and surface degradation rate of a mechanical component could be modeled. It was also surprisingly found that surface life fatigue and surface degradation rate could be predicted and characterized.

The system and method of the present invention are useful in predicting the surface life fatigue or surface degradation rate of mechanical components that are subject to repeated, cyclical mechanical and/or thermal stress. The system and method are useful, for example, with gears, bearings, splines, and springs. The system and method are particularly useful with interlocking/intermeshing gears, which are subject to repeated, cyclical mechanical stress. The system and method can be used with any type of gear, such as but not limited to a spur gear, worm gear, straight bevel gear, Zerol bevel gear, spiral bevel gear, helical gear, herringbone gear, double helical gear, hypoid gear, crossed helical gear, and the like.

The system and method are also useful in predicting the surface life fatigue of mechanical components that have other materials present at the surface, such as lubricants and/or coatings. The system and method takes into consideration the structure and properties of both the surface of mechanical components and the other materials present at the surface.

In the system and method of the present invention, modeling takes place in a series of steps. The system and method has the following steps: a) modeling on an atomistic scale; b) modeling on a mesoscale; c) modeling on a macroscale; and d) testing the mechanical component. Feedback may be obtained from a downstream step and provided to an upstream step for purposes of validation, e.g., adjustment of features, aspects, or algorithms. Step b) provides feedback to step a). Step c) provides feedback to step b). Step d) provides feedback to step c). Each feedback step is performed at least one time and is preferably performed two or more times. The system and method are easily adapted such that feedback steps can be performed via computer in an iterative manner many times, e.g., tens, hundreds, or thousands of times to enhance the accuracy of the overall model.

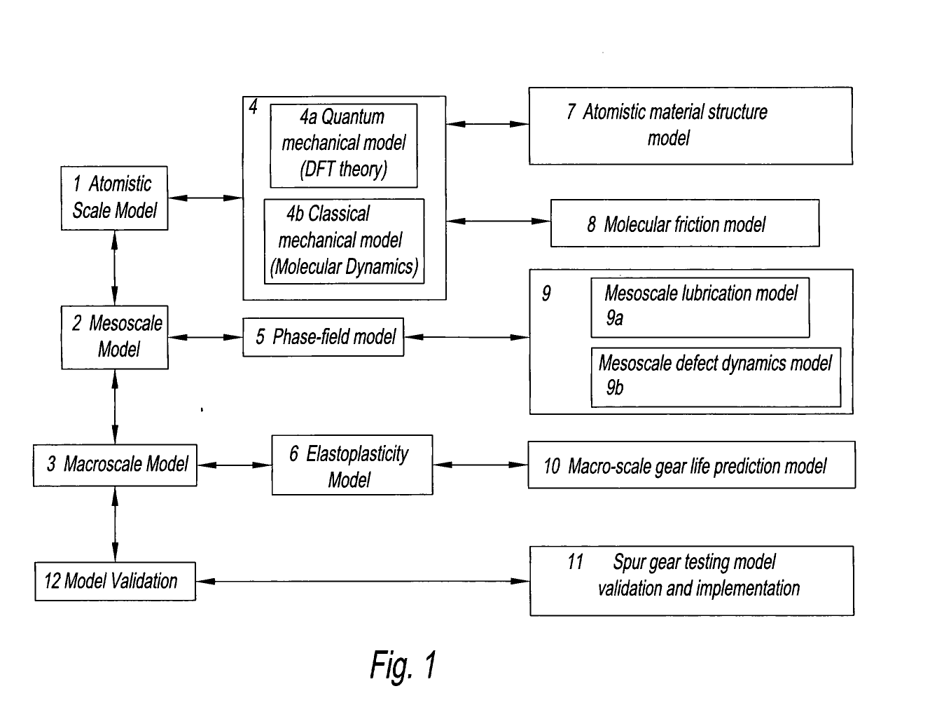

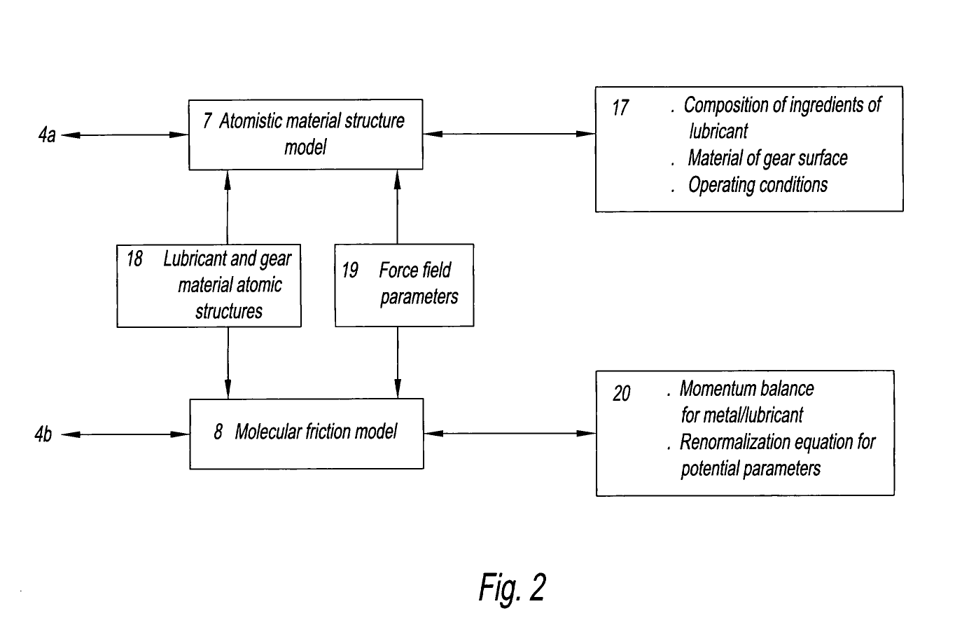

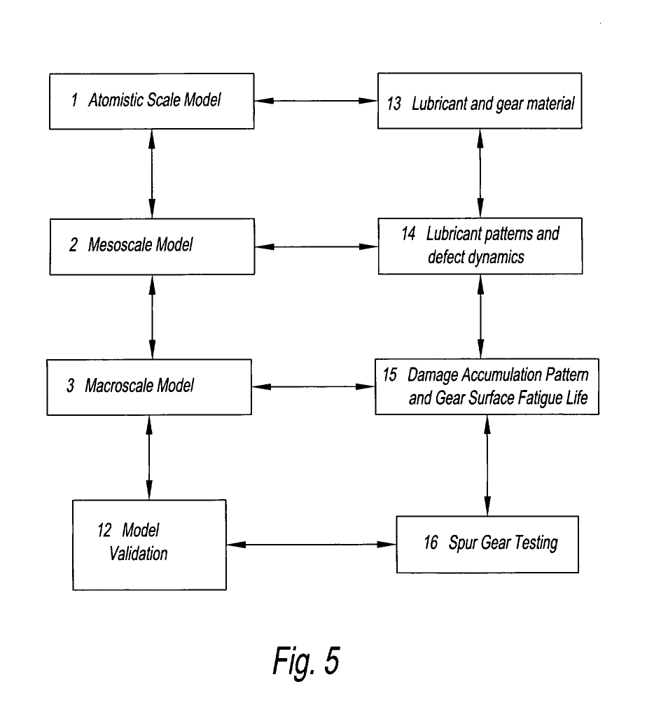

Atomistic scale models describe the structural, physical and chemical properties, and dynamics of groups of atoms or molecules. An atomistic scale model is shown in FIGS. 1, 2, and 5 and is referenced by the numeral 1 in FIGS. 1 and 5, and by the numeral 7 in FIG. 2.

One system and method of modeling atomistic scale behavior is with a quantum mechanical model, which is referenced by the numeral 4a. The quantum mechanical model may, for example, take the form of an atomistic material structure model, which is referenced by the numeral 7. Quantum mechanical models involve approximate solutions to Schrödinger's equation and take into account the electronic structure of atoms. One such quantum mechanical model relies on density functional theory (DFT), which is based on solving the many-particle Schröedinger equation for a model system of atoms. DFT provides structural, electronic, magnetic, and energy information about the atomic system. DFT can be used to predict atomistic structures of a lubricant and the material composing the surface(s) of the corresponding mechanical component as well as to predict the physical and chemical interaction between the lubricant and the surface (referenced as numeral 18). Additional properties of interest include lubricant composition, surface composition, and operating conditions (referenced as numeral 17). DFT also models force field parameters (referenced as numeral 19) for molecular dynamics simulations.

Another method of modeling atomistic scale behavior is with a classical mechanical model, such as one based on molecular dynamics and/or molecular friction. The classical mechanical model is referenced by the numeral 4b. The molecular friction model is referenced by the numeral 8. In classical mechanical models, particles are moved at each time step according to Newton's law and parameterized force fields. Classical mechanical models can be used to model lubricant-solid interfaces using molecular dynamics simulation. The models can be used to evaluate coefficient of friction as a function of surface roughness and lubricant layer thickness. Other properties of interest include the momentum balance for metal and the lubricant and the renormalization equation for potential parameters (referenced as numeral 20).

Modeling atomistic scale behavior is disclosed, for example, in Structure Dependence of NO Adsorption and Dissociation on Platinum Surfaces, by Q. Ge and M. Neurok, J. Am. Chem. Soc., 126, 1551 (2004), which is incorporated herein by reference.

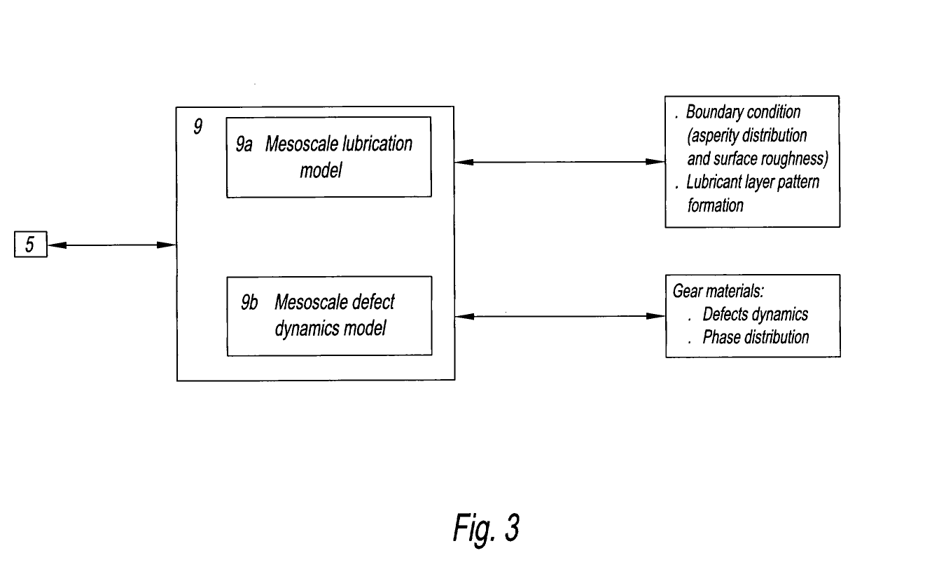

Mesoscale models describe a material's internal microstructure, including the shape, size, and spatial arrangement of phases, domains, and/or grains. Metals typically exhibit such structure. Mesoscale models are often used to describe defect distributions, such as dislocation configurations. Mesoscale models are shown, by way of example, in FIGS. 1, 3, and 5 and are generally referenced by the numeral 2 in FIGS. 1 and 5, and by the numeral 9 in FIG. 3.

One method of mesoscale modeling is based on phase field theory, which is referenced as numeral 5 for a phase field model. Phase field theory is used to describe interfacial pattern formation by assuming a constant value in the bulk phase and varying smoothly in the interfacial region.

Other mesoscale models are shown in FIG. 3. A mesoscale lubrication model is governed by such properties as boundary conditions, including asperity distribution and surface roughness, as well as lubricant layer pattern formation. The model based on mesoscale lubrication is referenced by the numeral 9a. A mesoscale defect dynamics model is governed by such properties as gear material properties, defect dynamics, and phase distribution. The mesoscale lubrication model is referenced by the numeral 9b.

Mesoscale modeling based on molecular dynamics of friction is disclosed, for example, in Effect of the Wall Roughness on Slip and Rheological Properties of Hexadecane in Molecular Dynamics Simulation of Couette Shear Flow Between Two Sinusoidal Walls, by A. Jabbarzadeh, J. D. Atkinson, and R. I. Tanner, Physical Review B, 61, 690 (2000), which is incorporated herein by reference. Mesoscale modeling based on phase field theory applied to defect dynamics is disclosed, for example, in Phase Field Microelasticity Theory and Simulation of Multiple Voids and Cracks in Single Crystals and Polycrystals under Applied Stress, by Y. U. Wang, Y. M. Jin, and A. G. Khachaturyan, Journal of Applied Physics, 91, 6435 (2002), which is incorporated herein by reference.

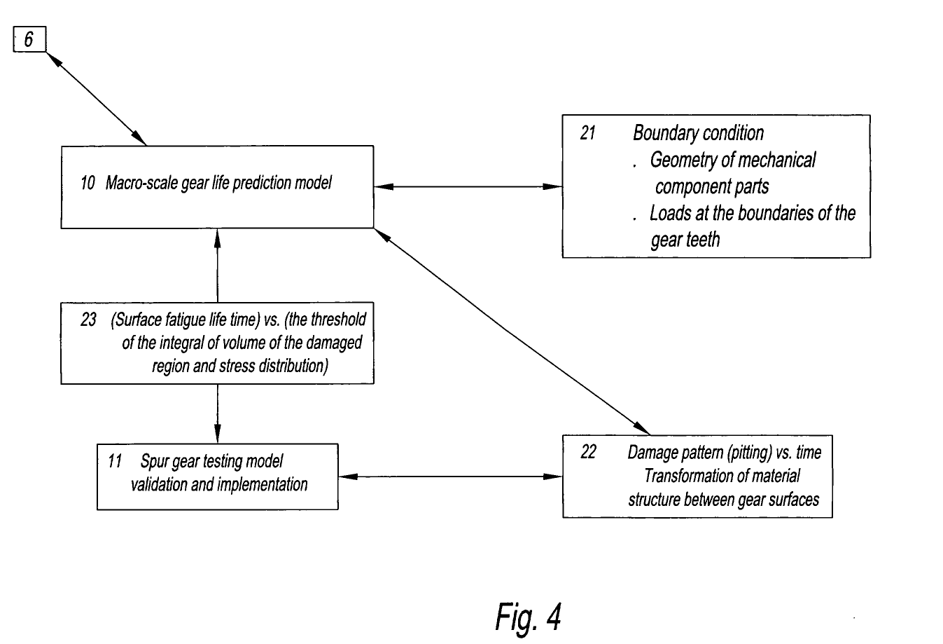

Macroscale models describe behavior using constitutive relations and empirical laws and are used when a continuum level description is desired. Macroscale modeling can be used to predict the number of cycles to failure for a mechanical component. Macroscale models are shown in FIGS. 1, 4, and 5 and are generally referenced by the numeral 3 in FIGS. 1 and 5, and by the numeral 10 in FIG. 4.

One method of macroscale modeling is based on elastoplasticity theory. The constitutive equations of elastoplasticity are used to describe the deformation and failure in continuum level materials simulation. An elastoplasticity lubrication model is referenced by the numeral 6. The model could, for example, evaluate effect of periodicity on lubrication. Properties of interest include, but are not limited to, geometry of mechanical component parts and loads at boundaries of the gear teeth (referenced as numeral 21). Elastoplasticity theory can be employed to develop a macroscale gear life prediction model, which is referenced as numeral 10.

Macroscale modeling is disclosed, for example, in Contact Mechanics in Tribology (Solid Mechanics and Its Applications), by I. G. Goryacheva, Kluwer Academic Publishers, Dordrecht/Boston/London, p. 244, 1998, and Contact Mechanics, by K. L. Johnson, Cambridge University Press, p. 506, 1987, both of which are incorporated herein by reference.

Actual testing is used to gather experimental data to validate, i.e., compare and ensure the accuracy of the macroscale prediction model. Actual testing is represented as model validation 12 in FIGS. 1 and 5.

The terms “model(s)” and “submodel(s)” are used interchangeably herein. The latter is used in describing scale models, e.g., mesoscale models, to eliminate confusion when the system as a whole is referred to as a model.

One embodiment of a system and method for modeling for predicting cycle life to surface failure for a lubricated gear is the following: a) structural and functional properties of the lubricant and the surface of the gear are calculated and optimized using atomistic simulation for input into a defect dynamics mesoscale model; b) residual plastic deformation behavior and modified elastic parameters are determined in the mesoscale model for input into a macroscale gear life prediction model; c) cycle lifetime prediction is determined in the macroscale model; d) actual cycle lifetime tests on the gear are carried out; and e) the actual test results are used to validate the macroscale gear life prediction model for prediction of further lifetimes.

FIG. 5 illustrates another embodiment of a system and method for modeling for predicting cycle life to surface failure for a lubricated spur gear. The system and method has the following steps: a) an atomistic scale model 1 that is governed by atomistic properties of the lubricant and the gear material (referenced by the numeral 13), b) a mesoscale model 2 that is governed by mesoscale properties of lubricant patterns and gear material defect dynamics (referenced by the numeral 14), c) a macroscale model 3 governed by damage accumulation pattern and gear surface fatigue life (referenced by the numeral 15), and d) actual testing of the spur gear (referenced by the numeral 16) is represented as model validation 12. Results of the testing are fed back to macroscale model 3 for validation purposes. The results from macroscale model 3 is in turn fed back to mesoscale model 2. The results from mesoscale model 2 is in turn fed back to atomistic model 1. Feedback from upstream models is in turn used to validate downstream models in sequence. The feedback between models is performed iteratively a plural number of times to obtain an accurate overall predictive model.

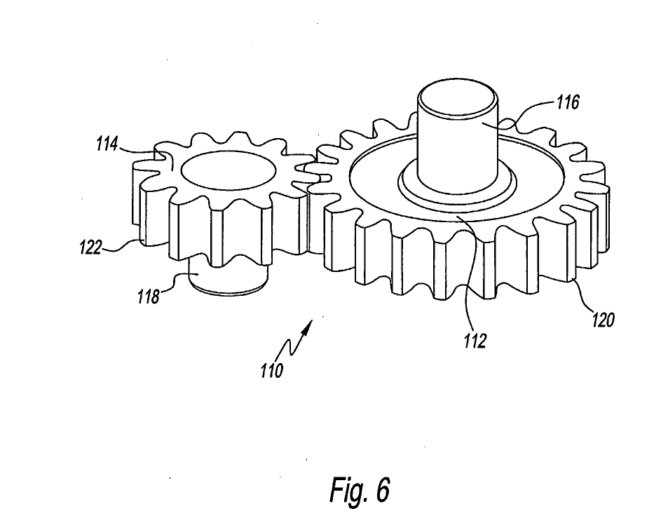

FIG. 6 illustrates a spur gear set 110, the operation of which can be modeled according to the method of the present invention. Spur gear set 110 has a bull gear 112 and a pinion 114. The pinion 114, by convention, is the smaller of the two gears. Spur gear set 110 is used to transmit motion and power between parallel shafts 116, 118. As shown in FIG. 6, gear 112 and pinion 114 have teeth 120 and 122, which are generally straight and radially disposed and run generally parallel to the shaft axes. Preferably, spur gear set 110 will have a lubricant in contact with the surfaces thereof (not shown).

The testing of spur gear set 110 can be represented, for example, by numeral 11 in FIGS. 1 and 4 as spur gear testing model (validation and implementation). Spur gear testing model 11 can be governed, for example, by boundary conditions 21. Testing can be carried out, for example, on damage pattern (pitting) versus time (transformation of material structure between gear surfaces), which is referenced as numeral 22 in FIG. 4. Testing can also be carried out, for example, on surface fatigue life time versus threshold of the integral of volume of the damaged region and stress distribution, which is referenced as numeral 23 in FIG. 4.

While the method of modeling is useful for prediction of surface fatigue life for a mechanical component, it is well within the scope of the invention for the method to be useful with a system of a multiple or plural number of interrelated mechanical components. The method is also useful with auxiliary components, such a lubricant(s) and/or coating(s) for a mechanical component(s).

While the method of modeling is directed to the prediction of surface fatigue life, it also has utility in carrying out related tasks such as characterization and/or optimization of a mechanical component or a system of multiple components. Modeling can also be used to aid in selecting auxiliary components, such as lubricants and coatings.

Surface life fatigue can be measured according to any method known in the art, such as standard spur-gear testing, in which two intermeshing gears are lubricated and rotated under torque loading to cause a desired magnitude of surface contact stress. Surface degradation rate can be measured according to any method known in the art, such as periodic interruption of the spur-gear test method for the direct examination of the contacting surfaces. An alternate method for detecting surface-contact degradation is the use of an in situ accelerometer to measure the vibration amplitude, which typically escalates during the course of testing.

The mechanical component(s) useful in the present method may be comprised of any known in the art, such as metals, plastics, and ceramics. Particularly useful are those of metals, which can include, but are not limited to, iron, nickel, chromium, copper, titanium, aluminum, vanadium, cobalt, alloys of the foregoing, and the like. Steel alloys of iron and one or more other metals are particularly useful.

Lubricants useful in conjunction with a mechanical component(s) include any known in the art, such a petroleum-based or silicon-based greases, liquids, waxes, functionalized hydrocarbons, amphoteric surfactants, emulsions, and oligomeric or polymeric water-based lubricants.

A mechanical component(s) may optionally have one or more coatings thereon. Coatings may be applied for various purposes, such as enhancement of lubricity and corrosion protection. In such instances, the model may take into consideration such coating(s) and the underlying substrate material. Coatings can be any known in the art, examples of which include but are not limited to thin film coatings deposited from vapor, electrochemical, oxidation-reduction, precipitation or other solution-based processes. Particularly useful coatings used on metals are carbonaceous coatings, such as those disclosed in U.S. Pat. No. 5,482,602.

The following examples are illustrative and are not to be construed as limiting of the present invention.

An illustrative instance of the use of multi-scale modeling is its application to power-transmission gears and systems of gears. It is highly desirable that life of such components or systems of components be predictable, with a high degree of fidelity and confidence, from known or straightforwardly determinable properties and characteristics of the materials and the operating conditions of the components or system. Such ability to predict component and system life enables the avoidance of the expensive and time-consuming “build and test” approach that is required in the absence of the predictive capability that is enabled by the multi-scale modeling approach that is taught herein. Moreover, it is well known that modeling approaches that are “single-scale,” such as finite-element models, are highly empirically based, rather than first-principles based, and require extensive testing to establish constants and scaling factors, without which such models would be ineffective and inaccurate.

It should be understood that the foregoing description is only illustrative of the present invention. Various alternatives and modifications can be devised by those skilled in the art without departing from the invention. Accordingly, the present invention is intended to embrace all such alternatives, modifications and variances that fall within the scope of the appended claims.

What is claimed is:

1. A method for modeling the surface fatigue life or surface degradation rate of a mechanical component, comprising:
a) modeling the surface fatigue life of the mechanical component on an atomistic scale to form an atomistic model;
b) modeling the surface fatigue life of the mechanical component on a mesoscale to form a mesoscale model;
c) modeling the surface fatigue life of the mechanical component on a macroscale to form a macroscale model; and
d) testing the surface fatigue life or surface degradation rate of the mechanical component to yield test results,
wherein feedback from said mesoscale model is employed at least once to validate said atomistic model, and wherein feedback from said macroscale model is employed at least once to validate said mesoscale model, and wherein feedback from said test results is employed at least once to validate said macroscale model.

2. The method of claim 1, wherein said atomistic model employs quantum mechanics.

3. The method of claim 2, wherein said atomistic model employs density functional theory.

4. The method of claim 1, wherein said atomistic model employs molecular dynamics.

5. The method of claim 1, wherein said atomistic model is governed at least in part by one or more factors selected from the group consisting of the constituent material of the surface of the mechanical component, composition of any lubricant present, operating conditions, and the momentum balance for the interface between the surface and any lubricant present.

6. The method of claim 1, wherein said mesoscale model employs phase field theory.

7. The method of claim 6, wherein said mesoscale model is governed at least in part by one or more factors selected from the group consisting of asperity distribution, roughness of the surface, layer pattern formation of any lubricant present, phase distribution, and defect dynamics.

8. The method of claim 1, wherein said macroscale model characterizes elastoplasticity.

9. The method of claim 8, wherein said macroscale model is governed at least in part by geometry of said mechanical component.

10. The method of claim 8, wherein said macroscale model is governed at least in part by loads at the boundaries of said mechanical component.

11. The method of claim 1, wherein said mechanical component is a gear.

12. The method of claim 9, wherein said mechanical component is a gear.

13. The method of claim 11, wherein there is a lubricant present at the surface of said gear.

14. The method of claim 13, wherein said atomistic model employs quantum mechanics, and wherein said mesoscale model employs phase field theory, and wherein said macroscale model employs elastoplasticity theory.

15. The method of claim 13, wherein said atomistic model employs molecular dynamics, and wherein said mesoscale model employs phase field theory, and wherein said macroscale model employs elastoplasticity theory.

16. An interactive, multiscale model for predicting surface fatigue life or surface degradation rate for a mechanical component, comprising in sequence
an atomistic submodel;
a mesoscale submodel;
a macroscale submodel; and
a test device for determining the surface fatigue life or surface degradation rate for a mechanical component,
wherein each of said submodels and said test device have an output, and wherein the output from said mesoscale submodel is employed to validate said atomistic submodel, and wherein the output from the macroscale submodel is employed to validate said mesoscale submodel, and wherein the output from said test device is employed to validate said macroscale submodel, and wherein the validation of each of said submodels occurs at least once.

17. The model of claim 16, wherein said atomistic submodel employs quantum mechanics.

18. The model of claim 17, wherein said atomistic submodel employs density functional theory.

19. The model of claim 16, wherein said atomistic submodel employs molecular dynamics.

20. The model of claim 16, wherein said atomistic submodel is governed at least in part by one or more factors selected from the group consisting of the constituent material of the surface of the mechanical component, composition of any lubricant present, operating conditions, and the momentum balance for the interface between the surface and any lubricant present.

21. The model of claim 16, wherein said mesoscale submodel employs phase field theory.

22. The model of claim 21, wherein said mesoscale submodel is governed at least in part by one or more factors selected from the group consisting of asperity distribution, roughness of the surface, layer pattern formation of any lubricant present, phase distribution, and defect dynamics.

23. The model of claim 16, wherein said macroscale submodel characterizes elastoplasticity.

24. The model of claim 23, wherein said macroscale submodel is governed at least in part by geometry of said mechanical component.

25. The model of claim 23, wherein said macroscale submodel is governed at least in part by loads at the boundaries of said mechanical component.

26. The model of claim 16, wherein said mechanical component is a gear.

27. The model of claim 26, wherein said mechanical component is a gear.

28. The model of claim 16, wherein there is a lubricant present at the surface of said gear.

29. The model of claim 16, wherein said atomistic submodel employs quantum mechanics, and wherein said mesoscale employs phase field theory, and wherein said macroscale submodel employs elastoplasticity theory.

30. The model of claim 16, wherein said atomistic submodel employs molecular dynamics, and wherein said mesoscale submodel employs phase field theory, and wherein said macroscale submodel employs elastoplasticity theory.
